(19) United States
(12) Patent Application Publication
(10) Pub. No.: US 2018/0025377 A1
(43) Pub. Date: Jan. 25, 2018

(54) SYSTEMS AND METHODS FOR EVALUATING EFFECTIVENESS OF OUTDOOR OR INDOOR ADVERTISEMENTS

(71) Applicant: STICKERRIDE LTD, LONDON (GB)

(72) Inventor: MIKHAIL MARCHENKO, Moscow (RU)

(21) Appl. No.: 15/216,637

(22) Filed: Jul. 21, 2016

(51) Int. Cl. G06Q 30/02; H04L 29/08; G06Q 50/00; G06F 17/11

(52) U.S. Cl. CPC G06Q 30/0243; G06F 17/11; H04L 67/306; G06Q 50/01; G06Q 30/0269

(57) ABSTRACT

Evaluating effectiveness of outdoor or indoor advertisements involves analysis of data on human user interaction with outdoor or indoor advertisements. This analysis is accomplished using a mobile application, which enables users to locate various items that the subjects in an advertising campaign, take pictures or videos and easily repost them in a personal account in social media in the form of the game or a quest. The described system generates the following results: comparative analysis of advertising objects used in an advertising campaign; effectiveness of given campaign as a whole compared to another campaign; effectiveness of a given advertising object in a specific campaign compared to the use of the same object in another campaign; comparative analysis of different items of creative content used in the same advertising campaign; and any and all other custom analytics as requested by the advertiser.

### BACKGROUND OF THE INVENTION

### Technical Field

The disclosed embodiments relate in general to advertising techniques, more specifically, to systems and methods for evaluating effectiveness of outdoor or indoor advertisements.

### Description of the Related Art

In addition to the classical outdoor advertising, which includes billboards with static content and electronic displays displaying dynamic advertising content, transit outdoor advertising, e.g. the advertising content placed on cars, trucks and other road or other surface or air vehicles, such as boats or aircraft, is becoming more end more popular, especially in large metropolitan areas such as New York City, Los Angeles as well as others. Such advertising content may be static, when the content displayed on the vehicle does not change, as in case of permanently affixed stickers or decals, or dynamic, when the vehicle is equipped with an electronic billboard displaying dynamic advertising content, such as video advertisements. In addition, an associated audio content may be provided.

As would be appreciated by persons of skill in the art, effectiveness of outdoor or indoor advertisements is a big and important question for any brand or media agency. A classical approach to evaluating the effectiveness of advertisements involves estimating a number of impressions generated by advertisement using statistical data (e.g. historical data on human and transport traffic in specific places, etc.) or technical equipment (e.g. cameras counting eyeballs, iBeacon/Bluetooth counting devices, etc). However, it is much more important for the advertiser to measure and evaluate the effect, which the advertisement had on real individuals and to be able to compare the respective advertisement effects corresponding to different locations and formats.

As would be appreciated by persons of ordinary skill in the art, in view of the above and other deficiencies of the conventional approach to evaluating effectiveness of outdoor or indoor advertisements, a new and improved advertisement evaluation approach would be highly desirable.

### SUMMARY OF THE INVENTION

The embodiments described herein are directed to methods and systems that substantially obviate one or more of the above and other problems associated with conventional approach for evaluating the effectiveness of advertisements.

In accordance with one aspect of the inventive concepts described herein, there is provided a computer-implemented method for calculating user incentives in connection with outdoor or indoor advertisement(s), the method being performed in connection with a computerized system comprising a central processing unit, a positioning device, a display device and a memory, the computer-implemented method comprising: using the central processing unit to post a photo or a video taken by a user in a social network; checking whether the posted photo or video is still available in the social network; if the posted photo or video is still available, determining a level of other user interaction with the posted photo or video; specifying a rate information applicable to an advertising campaign corresponding to the posted photo or video and the social network; and calculating a number of points (P) earned by the user for the posted photo or video in the social network based on determined rate information and the determined level of interaction.

In one or more embodiments, the level of other user interaction with the posted photo or video is determined based on a number (L) of “likes” collected by the posted photo or video in the social network.

In one or more embodiments, the level of other user interaction with the posted photo or video is determined based on a number of reposts (S) collected by the posted photo or video in the social network.

In one or more embodiments, the level of other user interaction with the posted photo or video is determined based on a number of views (V) of the posted photo or video in the social network.

In one or more embodiments, the rate information comprises a price per friend/follower (pF), price per like (pL) and price per repost (pS), limit for friend/follower (limF), limit for likes (limL) and limit for reposts (limS), price per watched video (pV) and limit for number of times video can be watched (limV).

In one or more embodiments, the method further comprises determining a number (F) of friends and followers of a profile of the user in the social network, wherein the number of points (P) earned by the user for the posted photo in the social network is calculated according to a formula: P=if(F>limF; LOG(F;2)*pF*limF/LOG(limF;2); pF*F)+if(L>limL; LOG(L;2)*pL*limL/LOG(limL;2); pL*L)+if(S>limS; LOG(S;2)*pS*limS/LOG(limS;2); pS*S) or any other function that is linear to number of friends, number of likes, number of reposts and switches to logarithmic after a certain limit. For posted video formula is going to be: P=if(V>limV; LOG(V;2)*pV*limV/LOG(limV;2); pV*V)+if(L>limL; LOG(L;2)*pL*limL/LOG(limL;2); pL*L)+if(S>limS; LOG(S;2)*pS*limS/LOG(limS;2); pS*S) or any other function that is linear to number of times video was watched, number of likes, number of reposts and switches to logarithmic after a certain limit.

In one or more embodiments, checking whether the posted photo or video is still available in the social network during a predetermine period of time comprises determining whether the posted photo or video exists and can be accessed without any restriction by any user.

In one or more embodiments, if the posted photo or video is not available to everybody, it is treated as “unavailable”.

In accordance with another aspect of the inventive concepts described herein, there is provided a computer-implemented method for evaluating effectiveness of outdoor or indoor advertisement(s), the method being performed in connection with a computerized system comprising a central processing unit, a positioning device, a display device and a memory, the computer-implemented method comprising: receiving data on a plurality of postings made for a predetermined advertising campaign, associating each posting of the plurality of postings with an advertisement object of a plurality of advertisement objects; and determining the effectiveness of outdoor or indoor advertisement(s) based on statistical analysis of a number of associated postings.

In one or more embodiments, the method further comprises computing, for each of the plurality of postings, an engagement rate.

In one or more embodiments, each posting of the plurality of postings is associated with the advertisement object of the plurality of advertisement objects by means of an algorithm for building Voronoi diagram.

In one or more embodiments, the method further comprises comprising using statistical distribution of advertisement objects comprising groups of best and worst performing objects in the predetermined advertising campaign, average performance of advertising objects in the predetermined advertising campaign compared to average for other campaigns in a database, comparison of performance of the advertising object among several advertising campaigns and other analytics.

In one or more embodiments, the method further comprises using standard computational instruments to determine statistical distribution of creatives, comprising groups of best and worst performing creatives in the predetermined advertising campaign, average performance of creative in the predetermined advertising campaign compared to average for other campaigns in a database, comparison of performance of creatives located at the advertising object among several advertising campaigns (can be helpful to determine social demography and profile of audience around this advertising object) and other analytics.

In one or more embodiments, the engagement rate comprises a first engagement rate computed based on a number of likes of the posting.

In one or more embodiments, the method further comprises determining a number (F) of friends and followers of a profile of the user in the social network, wherein the first engagement rate is computed by dividing the number of likes of the posting by a number of friends and followers of a corresponding user who made the posting.

In one or more embodiments, the engagement rate comprises a second engagement rate calculated based on a number of reposts of the posting.

In one or more embodiments, the method further comprises determining a number (F) of friends and followers of a profile of the user in the social network, wherein the second engagement rate is computed by dividing the number of reposts of the posting by a number of friends and followers of a corresponding user who made the posting.

In one or more embodiments, the engagement rate comprises a third engagement rate calculated based on a number of views of the posting.

In one or more embodiments, the method further comprises determining a number (F) of friends and followers of a profile of the user in the social network, wherein the third engagement rate is computed by dividing the number of views of the posting by a number of friends and followers of a corresponding user who made the posting.

In accordance with yet another aspect of the inventive concepts described herein, there is provided a non-transitory computer-readable medium embodying a set of computer-executable instructions, which, when executed in a computerized system comprising a central processing unit, a positioning device, a display device and a memory, cause the computerized system to perform a computer-implemented method for calculating user incentives in connection with outdoor or indoor advertisement(s), the method comprising: using the central processing unit to post a photo or a video taken by a user in a social network; checking whether the posted photo or video is still available in the social network; if the posted photo or video is still available, determining a level of other user interaction with the posted photo or video; specifying a rate information applicable to an advertising campaign corresponding to the posted photo or video and the social network; and calculating a number of points (P) earned by the user for the posted photo or video in the social network based on determined rate information and the determined level of interaction.

In one or more embodiments, the level of other user interaction with the posted photo or video is determined based on a number (L) of “likes” collected by the posted photo or video in the social network.

In one or more embodiments, the level of other user interaction with the posted photo or video is determined based on a number of reposts (S) collected by the posted photo or video in the social network.

In one or more embodiments, the level of other user interaction with the posted photo or video is determined based on a number of views (V) of the posted photo or video in the social network.

In one or more embodiments, the rate information comprises a price per friend/follower (pF), price per like (pL) and price per repost (pS), limit for friend/follower (limF), limit for likes (limL) and limit for reposts (limS), price per watched video (pV) and limit for number of times video can be watched (limV).

In one or more embodiments, the method further comprises determining a number (F) of friends and followers of a profile of the user in the social network, wherein the number of points (P) earned by the user for the posted photo in the social network is calculated according to a formula: P=if(F>limF; LOG(F;2)*pF*limF/LOG(limF;2); pF*F)+if(L>limL; LOG(L;2)*pL*limL/LOG(limL;2); pL*L) if(S>limS; LOG(S;2)*pS*limS/LOG(limS;2); pS*S) or any other function that is linear to number of friends, number of likes, number of reposts and switches to logarithmic after a certain limit. For posted video formula is going to be: P=if(V>limV; LOG(V;2)*pV*limV/LOG(limV;2); pV*V)+if(L>limL; LOG(L;2)*pL*limL/LOG(limL;2); pL*L)+if(S>limS; LOG(S;2)*pS*limS/LOG(limS;2); pS*S) or any other function that is linear to number of times video was watched, number of likes, number of reposts and switches to logarithmic after a certain limit.

In one or more embodiments, checking whether the posted photo or video is still available in the social network during a predetermine period of time comprises determining whether the posted photo or video exists and can be accessed without any restriction by any user.

In one or more embodiments, if the posted photo or video is not available to everybody, it is treated as “unavailable”.

In accordance with yet another aspect of the inventive concepts described herein, there is a non-transitory computer-readable medium embodying a set of computer-executable instructions, which, when executed in a computerized system comprising a central processing unit, a positioning device, a display device and a memory, cause the computerized system to perform a computer-implemented method for evaluating effectiveness of outdoor or indoor advertisement(s), the method comprising: receiving data on a plurality of postings made for a predetermined advertising campaign; associating each posting of the plurality of postings with an advertisement object of a plurality of advertisement objects; and determining the effectiveness of outdoor or indoor advertisement(s) based on statistical analysis of a number of associated postings.

In one or more embodiments, the method further comprises computing, for each of the plurality of postings, an engagement rate.

In one or more embodiments, each posting of the plurality of postings is associated with the advertisement object of the plurality of advertisement objects by means of an algorithm for building Voronoi diagram.

In one or more embodiments, the method further comprises comprising using statistical distribution of advertisement objects comprising groups of best and worst performing objects in the predetermined advertising campaign, average performance of advertising objects in the predetermined advertising campaign compared to average for other campaigns in a database, comparison of performance of the advertising object among several advertising campaigns and other analytics.

In one or more embodiments, the method further comprises using standard computational instruments to determine statistical distribution of creatives, comprising groups of best and worst performing creatives in the predetermined advertising campaign, average performance of creative in the predetermined advertising campaign compared to average for other campaigns in a database, comparison of performance of creatives located at the advertising object among several advertising campaigns (can be helpful to determine social demography and profile of audience around this advertising object) and other analytics.

In one or more embodiments, the engagement rate comprises a first engagement rate computed based on a number of likes of the posting.

In one or more embodiments, the method further comprises determining a number (F) of friends and followers of a profile of the user in the social network, wherein the first engagement rate is computed by dividing the number of likes of the posting by a number of friends and followers of a corresponding user who made the posting.

In one or more embodiments, the engagement rate comprises a second engagement rate calculated based on a number of reposts of the posting.

In one or more embodiments, the method further comprises determining a number (F) of friends and followers of a profile of the user in the social network, wherein the second engagement rate is computed by dividing the number of reposts of the posting by a number of friends and followers of a corresponding user who made the posting.

In one or more embodiments, the engagement rate comprises a third engagement rate calculated based on a number of views of the posting.

In one or more embodiments, the method further comprises determining a number (F) of friends and followers of a profile of the user in the social network, wherein the third engagement rate is computed by dividing the number of views of the posting by a number of friends and followers of a corresponding user who made the posting.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates a logical diagram of one exemplary embodiment of an inventive computerized system for evaluating effectiveness of outdoor or indoor advertisement(s).

FIG. 2 illustrates exemplary internal data and command flows between various components of the inventive computerized system for evaluating effectiveness of outdoor or indoor advertisement(s) shown in FIG. 1.

FIG. 3 illustrates an exemplary block diagram of an embodiment of a software algorithm for calculating user incentives in connection with outdoor or indoor advertisement(s) performed in conjunction with the computerized system shown in FIG. 1.

FIG. 4(a) illustrates an exemplary embodiment of an algorithm for processing of analytical data to compute effectiveness of advertising inventory used outdoor/indoor campaign.

FIG. 4(b) illustrates an exemplary embodiment of an algorithm for processing of analytical data to compute effectiveness of creative used in outdoor/indoor advertising campaign.

FIGS. 5(a), 5(b) and 5(c) illustrate exemplary embodiments of a user interface of the aforesaid computerized system for evaluating effectiveness of outdoor or indoor advertisement(s) shown in FIG. 1.

FIG. 6 illustrates an exemplary embodiment of a computerized mobile system that could be used as the user's mobile device 2 in connection with the computerized system for evaluating effectiveness of outdoor or indoor advertisement(s) shown in FIG. 1.

FIG. 7 illustrates an exemplary embodiment of a computerized server system 3, which could be used, for example, as the server of the inventive computerized system for evaluating effectiveness of outdoor or indoor advertisement(s).

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

To address the above and other problems associated with the conventional technology, one or more embodiments described herein implement various exemplary computerized systems and computer-implemented methods for evaluating effectiveness of outdoor or indoor advertisement(s).

In one or more embodiments, evaluating effectiveness of outdoor or indoor advertisements involves analysis of data on human user interaction with outdoor or indoor advertisements. In one exemplary embodiment, this analysis is accomplished using a mobile application executing on a mobile computing device such as a smartphone or a tablet, which enables users to locate various items that are the objects in an advertising campaign, take pictures or videos and easily repost them in a personal account in social media in the form of the game or a quest. On a backend side, there are provided computerized systems and computer-implemented methods, which automatically compute and range respected quality and engagement for the set of advertising objects and creative used in outdoor or indoor advertising campaigns using the analysis of user-generated content published in social media.

In one or more embodiments, an implementation of the described computerized system generates one or more of the following results: 1) comparative analysis of advertising objects used in an advertising campaign; 2) effectiveness of given campaign as a whole compared to another campaign; 3) effectiveness of a given advertising object in a specific campaign compared to the use of the same object in another campaign; 4) comparative analysis of different items of creative content used in the same advertising campaign; and 5) any and all other custom analytics as requested by the advertiser.

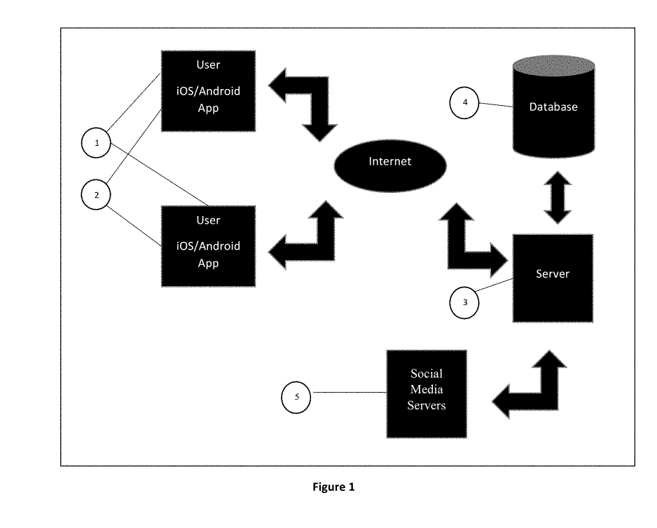

FIG. 1 illustrates a logical diagram of one exemplary embodiment of an inventive computerized system for evaluating effectiveness of outdoor or indoor advertisement(s). In one or more embodiments, in FIG. 1, an element 1 designates a human user with a smartphone who has been previously registered with the computerized system and who has at list one social media account (e.g. Facebook, Instagram, etc. account) linked to his or her profile in the aforesaid computerized system.

In one or more embodiments, an element 2 in FIG. 1 designates each user's 1 smartphone with an iOS or Android mobile application (not shown), the functionality of which will be described in detail below. When the user 1 makes a photo or video using this mobile application, the aforesaid mobile application transmits the acquired photo or video to a server (which will be described below) together with GPS position or other location information and a list of social media network(s) where the user decided to post the acquired photo or video.

In one or more embodiments, an element 3 in FIG. 1 designates a server, which is a part of the described computerized system for evaluating effectiveness of outdoor or indoor advertisement(s). The aforesaid server 3 is communicatively connected to a data network, such as the Internet and is configured to collect data from all users, automatically post predetermined content to various social media networks, monitor the safety of the aforesaid social network postings and perform any and all necessary computations to present analytics about the postings in the social media and effectiveness of the outdoor or indoor advertising campaign(s).

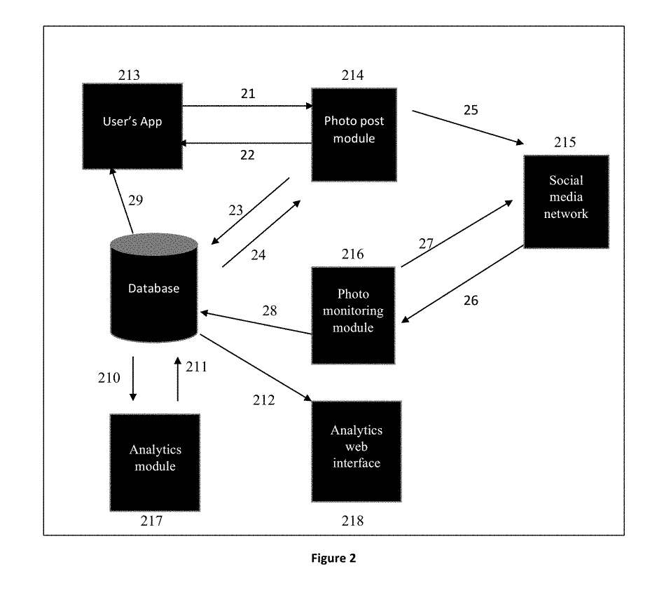

In one or more embodiments, an element 4 in FIG. 1 designates an advertising database, which is a part of the described computerized system for evaluating effectiveness of outdoor or indoor advertisement(s) shown in FIG. 2. In one or more embodiment, the advertising database 4 stores and manages any and all information about the user 1 as well as all the parameters of advertising campaigns, including, without limitation, advertising rates and/or other costs associated with posting of advertisements to different social media networks, limitations on such postings as well as other parameters of the advertising campaign.

In one or more embodiments, an element 5 in FIG. 1 designates one or more social media servers that could be part of a third party social network, such as Facebook, VKontakte, Instagram, Twitter and/or any other presently available or future social media networks. The elements of the inventive computerized system for evaluating effectiveness of outdoor or indoor advertisement(s) shown in FIG. 1 may be interconnected via a data network, such as the Internet or any other suitable communication interconnect.

FIG. 2 illustrates exemplary internal data and command flows between various components of the inventive computerized system for evaluating effectiveness of outdoor or indoor advertisement(s) shown in FIG. 1. Specifically, in one or more embodiments, a data transfer 21 takes place between the user's mobile application 213 and a photo or video post module 214 when the user makes a posting of a photo or a video. Here, the mobile application 213 sends to the server the photo or video, identifier (ID) of the user, advertising campaign ID, GPS position (where the photo or video was made), as well as a list of social media networks with permissions to make the postings to.

In one or more embodiments, a data transfer 22, which subsequently takes place between the photo or video post module 214 and the user's mobile application 213, is performed when the server sends the list of active advertising campaigns with rates applicable to the user, current status of posts made by user and the total number of points earned by the user for every post made.

In one or more embodiments, a data transfer 23, which subsequently takes place between the photo or video post module 214 and the database 4 involves the taken photo or video together with the corresponding GPS position, the user ID, as well as the advertising campaign ID.

In one or more embodiments, a data transfer 24, which subsequently takes place between the database 4 and the photo or video post module 214, which takes place after the aforesaid data transfer 23, includes text and/or the appropriate hashtags to be attached to the post for a specific advertising campaign ID.

In one or more embodiments, a data transfer 25, which subsequently takes place between the photo or video post module 214 and the social media network 215, includes the taken photo or video, permission to make the posting on behalf of the user, as well as text and/or hashtags to attach to the aforesaid post.

In one or more embodiments, a query 26 subsequently issued by the social media network 215 to the photo or video monitoring module 216 queries whether the given photo or video still exist in the social media network. In one embodiment, the response to the query is a Boolean variable (taking value 1 for exists and 0 for does not exist). The query 26 may also request a number of followers of the user with the specific user ID in each social network, a number of likes of a given photo or video in each social media network, as well as a number of reposts of a given photo or video in each social media network.

In one or more embodiments, a data transfer 27, which subsequently takes place between the photo or video monitoring module 216 and the social media network 21, which is responsive to the query 26, includes a photo or video ID and the permissions necessary to obtain specific data from the social media network.

In one or more embodiments, a data transfer 28, which subsequently takes place between the photo or video monitoring module 216 and the database 4 returns, for each photo or video ID, a number of followers of the user with the specific user ID in each social network, a number of likes of a given photo or video in each social media network, as well as a number of reposts of a given photo or video in each social media network at the end of monitoring period (or null if photo or video was deleted from social media networks by the user during the monitoring period).

In one or more embodiments, a data transfer 29, which subsequently takes place between the database 4 and the user's mobile application 213, includes a number of points earned by the user for given photo or video (as a sum of points for photo or video in each social media network), all data about the corresponding advertising campaign (rates for photos or videos for each social media network, as well as a list of GPS locations of all objects participating in outdoor/indoor advertising campaigns, which may be static and dynamic (location of cars with stickers for instance)).

In one or more embodiments, a data transfer 210, which subsequently takes place between the database 4 and an analysis module 217, includes, for each advertising campaign and a photo or video within the campaign, all information stored in the database 4 regarding the photo or video (e.g. GPS location, user ID of the corresponding user who captured the photo or video, a number of followers/likes or reposts for this photo or video, as well as the corresponding user ID in each social media network) as well as information on the advertising campaign (e.g. rates for social media accounts, GPS location and description of all physical objects participating in outdoor or indoor advertising campaign).

In one or more embodiments, a data transfer 211, which subsequently takes place between the analysis module 217 and the database 4, includes a number of points earned by user for any given published photo or video as well as the processed analytical data for the advertising campaign.

In one or more embodiments, a data transfer 212, which subsequently takes place between the database 4 and an analysis web interface 218, includes any and all analytical data to present to the user in a graphical and/or numerical form suitable for the convenient viewing.

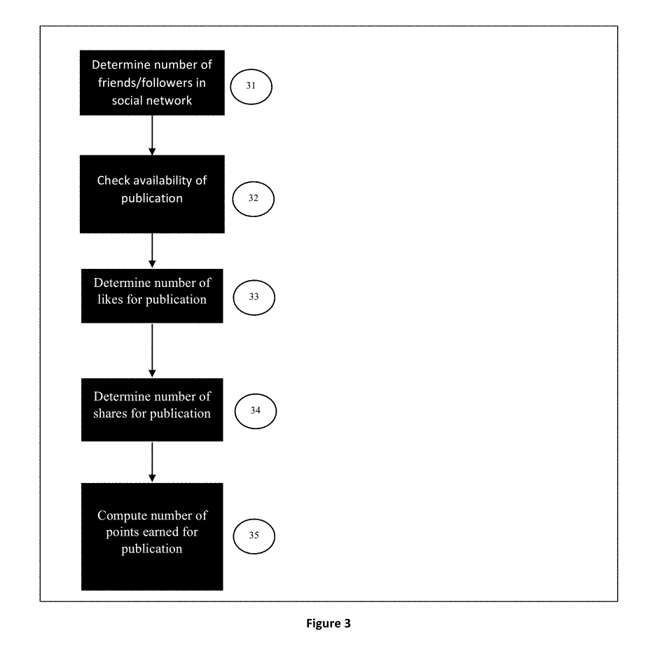

FIG. 3 illustrates an exemplary block diagram of an embodiment of a software algorithm for calculating user incentives in connection with outdoor or indoor advertisement(s) performed in conjunction with the computerized system shown in FIG. 1. Specifically, the shown algorithm computes the number of points earned by a user for a given photo or video posting.

In one or more embodiments, at an initial step 31, the user publishes a photo or a video in a social network with the help of the mobile application 213. In addition, in this step, a number of user's friends and followers of user's profile in this social network (F for reference below) is obtained.

In one or more embodiments, at a subsequent step 32, which is performed upon lapsing of a certain period of time, which can be adjusted in the settings (by default it is 5 days), the aforesaid algorithm checks whether user user's posting is still available in social network. Specifically, the algorithm checks whether the posting exists and can be accessed without any restriction by any user. In one exemplary embodiment, if the posting has settings “available to user's friends only,” it would be treated as “unavailable”. The algorithm subsequently returns 0 if the posting is unavailable. Otherwise, it proceeds to the next step 33.

In one or more embodiments, if at the previous step 32 the algorithm has determined that posting is (still) available, at a subsequent step 33 the aforesaid algorithm proceeds to determine a number of “likes” collected by the posting in the social network (if such “likes” exist in the social network, otherwise it's zero). This determined number of “likes” is designated with the letter L for purposes of the computation provided below.

In one or more embodiments, if at the previous step 32 the algorithm has determined that the posting is (still) available, at a subsequent step 34 the aforesaid algorithm obtains a number of reposts collected by the respective posting in the social network (if reposts are applicable (e.g. exist in) for the social network, otherwise it's zero). The number of reposts is designated with a letter S for purposes of the computation provided below.

In one or more embodiments, at subsequent step 35, the aforesaid algorithm reads a rate card for the advertising campaign corresponding to the given publication and a given social network from the database 4, which may be a price per friend/follower (pF), price per like (pL) and price per repost (pS), limit for friend/follower (limF), limit for likes (limL) and limit for reposts (limS). The algorithm then returns a number of points P earned by user for a given posting in a given social network, which is calculated according to the following formula:

P=if(F>limF;LOG(F;2)*pF*limF/LOG(limF;2);pF*F)+if(L>limL;LOG(L;2)*pL*limL/LOG(limL;2);pL*L)+if(S>limS;LOG(S;2)*pS*limS/LOG(limS;2);pS*S)

Mathematically, it means that the algorithm switches from linear payout function to logarithmic after certain level.

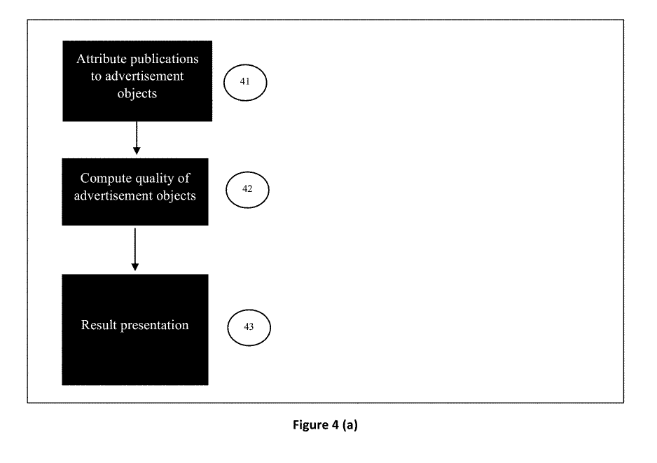

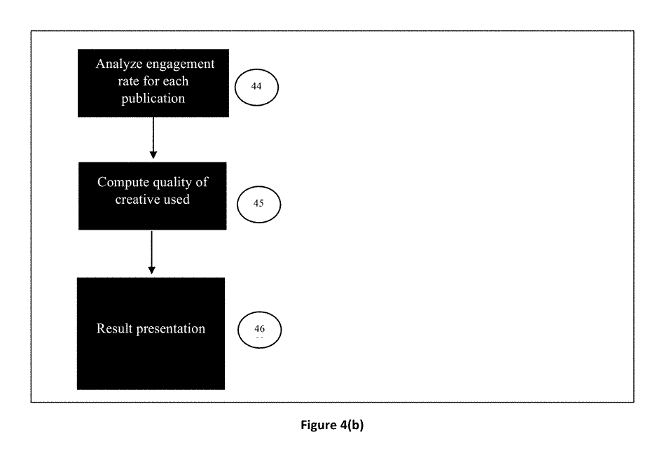

FIG. 4(a) illustrates an exemplary embodiment of an algorithm for processing of analytical data to compute effectiveness of advertising inventory used outdoor/indoor campaign.

Step 41: On input algorithm receive the set of publications made for the given advertising campaign (for each publication we have GPS location, number of likes, number of reposts and number of friends/followers in social network collected by this publication) and set of advertisement objects (names with GPS locations).

We process each publication and assign it to one of the advertisement object (so each object has a set of unique publications after that). In order to do it we use algorithm for Voronoi Diagram (https://en.wikipedia.org/wiki/Voronoi_diagram) on with two sets of GPS locations (advertisement objects as a “seeds” and publications as second set). As a result, we are getting unique set of publications associated with each advertising object.

Step 42: For each advertisement object we calculate number of publications (let it be N) attributable to it (from the step 41)

Step 43: For each advertisement object we have N—number of publications associated with it from step 42. We use standard computational instruments to determine statistical distribution of advertisement objects based on N and total number of publications in the campaign, like groups of best and worst performing objects in this campaign, average performance of advertising objects in this campaign compared to average for other campaigns in database, comparison of performance of same advertising object among several advertising campaigns and other analytics

FIG. 4(b) illustrates an exemplary embodiment of an algorithm for processing of analytical data to compute effectiveness of creative used in outdoor/indoor advertising campaign.

Step 44: On input algorithm receive the set of publications made for the given advertising campaign (for each publication we have GPS location, number of likes, number of reposts and number of friends/followers in social network collected by this publication) and set of advertisement objects (names with GPS locations). For each publication we compute engagement rate one and two.

ER1={number of likes}/{number of friends and followers}

ER2={number of reposts}/{number of friends and followers}

ER3={number of views}/{number of friends and followers} (this metrics available only if video were used in campaign)

If likes or reposts are unavailable in a given social network, we use just one engagement rate

Step 45: From step 41 above we know attribution of each publication to advertising object and hence knew attribution to media creative used on this advertising object in a given campaign. If campaign had just one type of creative than all publications attributable to one basket and can be compared on to creative used in other campaigns. If campaign had several creative used, we are getting publications attributable to each creative (basket) and then can compare them to each other and to creatives used in other advertising campaigns

For each creative we calculate average ER1, ER2 and ER3 of publications in respective basket.

Step 46: We have two or three numbers for each creative AER1, AER2 and AER3 from step 45. We use standard computational instruments to determine statistical distribution of creatives based on AER1, AER2 and AER3, like groups of best and worst performing creatives in this campaign, average performance of creative in this campaign compared to average for other campaigns in database, comparison of performance of creatives located at the same advertising object among several advertising campaigns (can be helpful to determine social demography and profile of audience around this advertising object) and other analytics.

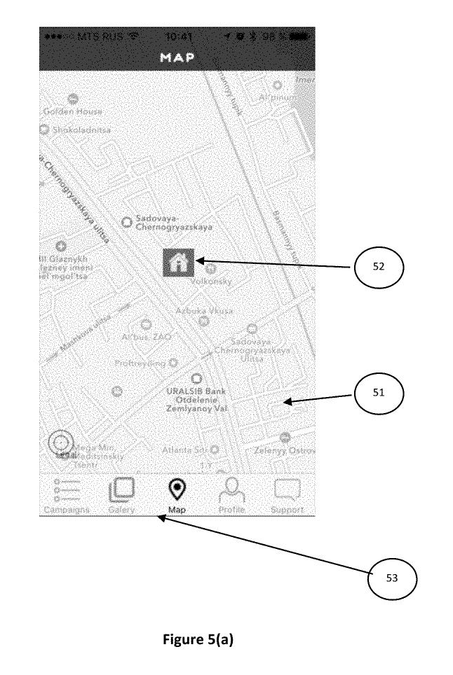

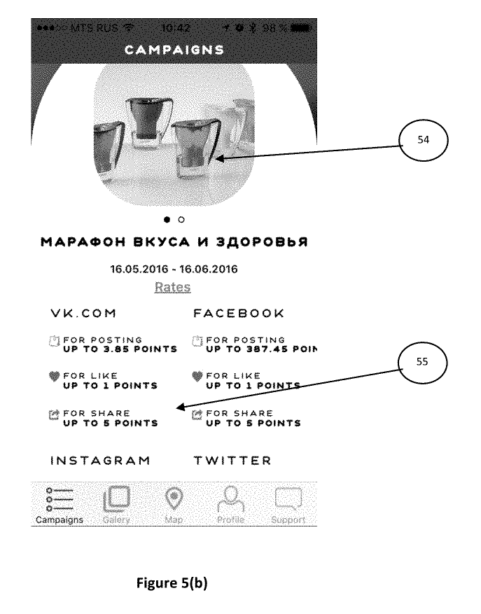

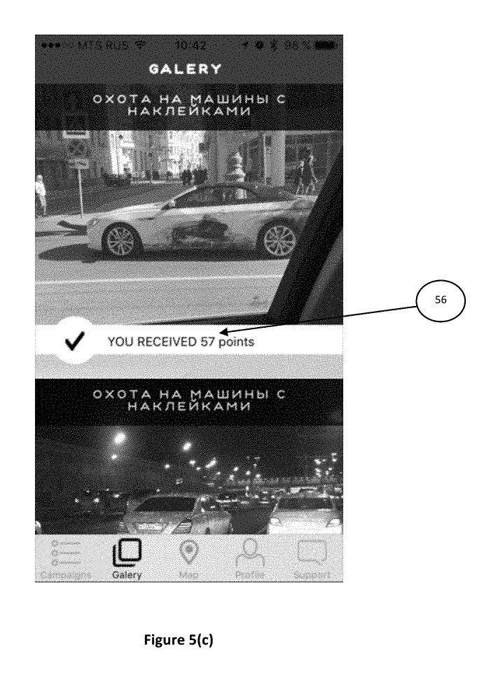

FIGS. 5(a), 5(b) and 5(c) illustrate exemplary embodiments of a user interface of the aforesaid computerized system for evaluating effectiveness of outdoor or indoor advertisement(s) shown in FIG. 1.

In one or more embodiments, an element 51 in FIG. 5(a) is a map showing details around the current location of the user.

In one or more embodiments, an element 52 in FIG. 5(a) is an advertising object on the map 51 from one of the ongoing advertising campaigns.

In one or more embodiments, an element 53 in FIG. 5(a) is a navigation toolbar, wherein the user can switch between Campaigns, Gallery, Map, Profile and Support GUI views.

In one or more embodiments, an element 54 in FIG. 5(b) is a scrollable list of available advertising campaigns.

In one or more embodiments, an element 55 in FIG. 5(b) is a rate for posting in different social media accounts (please refer to step 35 described above).

In one or more embodiments, an element 56 in FIG. 5(c) is a gallery with publication made and a number of points earned for each publication (please refer to the step 35 described above).

### Computing Platforms

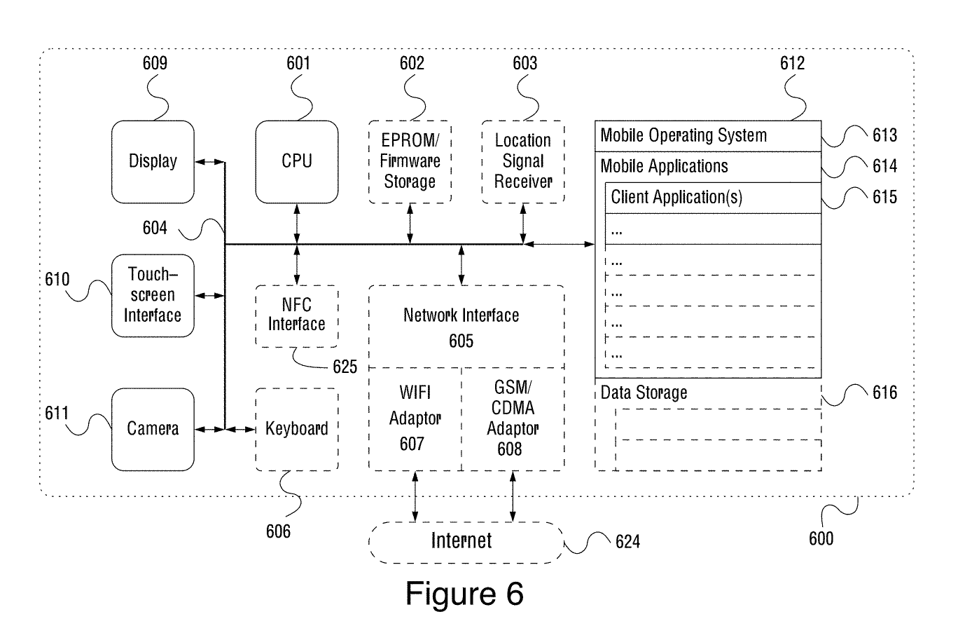

FIG. 6 illustrates an exemplary embodiment of a computerized mobile system 600 that could be used as the user's mobile device 2 in connection with the system shown in FIG. 1. In one or more embodiments, the computerized mobile system 600 may be implemented within a form factor of a mobile computing device, such as a smartphone, a personal digital assistant (PDA), a tablet computer, or a smart watch, all of which are widely available commercially and are well known to persons of skill in the art.

The computerized system 600 may include a data bus 604 or other interconnect or communication mechanism for communicating information across and among various hardware components of the mobile computerized system 600, and a central processing unit (CPU or simply processor) 601 coupled with the data bus 604 for processing information and performing other computational and control tasks. Computerized system 600 also includes a memory 612, such as a random access memory (RAM) or other dynamic storage device, coupled to the data bus 604 for storing various information as well as instructions to be executed by the processor 601. The memory 612 may also include persistent storage devices, such as a magnetic disk, optical disk, solid-state flash memory device or other non-volatile solid-state storage devices.

In one or more embodiments, the memory 612 may also be used for storing temporary variables or other intermediate information during execution of instructions by the processor 601. Optionally, computerized system 600 may further include a read only memory (ROM or EPROM) 602 or other static storage device coupled to the data bus 604 for storing static information and instructions for the processor 601, such as firmware necessary for the operation of the computerized system 600, basic input-output system (BIOS), as well as various configuration parameters of the computerized system 600.

In one or more embodiments, the computerized system 600 may incorporate a display device 609, which may be also coupled to the data bus 604, for displaying various information to a user of the computerized system 600, such as the user interface screens shown in FIGS. 4 and 5. In an alternative embodiment, the display device 609 may be associated with a graphics controller and/or graphics processor (not shown). The display device 609 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 609 may be incorporated into the same general enclosure with the remaining components of the computerized system 600. In an alternative embodiment, the display device 609 may be positioned outside of such enclosure.

In one or more embodiments, the computerized system 600 may further incorporate an near field communication (NFC) interface 625 connected to the data bus 604 and configured to communicate with one or more NFC devices for determining its geographical position.

In one or more embodiments, the computerized system 600 may incorporate one or more input devices, such as a touchscreen interface 610 for receiving tactile commands, a camera 611 for acquiring still images and video of various objects, as well as a keyboard 606, which all may be coupled to the aforesaid data bus 604 for communicating information, including, without limitation, images and video, as well as user command selections to the processor 601. In an alternative embodiment, input devices may include a system for tracking eye movements of the user (not shown), which may be used to indicate to the computerized system 600 the command selection by the user.

In one or more embodiments, the computerized system 600 may additionally include a location signal receiver 603 configured to perform scan for GPS signal or beacons and supply scan data described above to the processor 601 via the data bus 604.

In one or more embodiments, the computerized system 600 may additionally include a communication interface, such as a network interface 605 coupled to the data bus 604. The network interface 605 may be configured to establish a connection between the computerized system 600 and the Internet 624 using at least one of WIFI interface 607 and the cellular network (GSM or CDMA) adaptor 608. The network interface 605 may be configured to provide a two-way data communication between the computerized system 600 and the Internet 624. The WIFI interface 607 may operate in compliance with 802.11a, 802.11b, 802.11g and/or 802.11n protocols as well as Bluetooth protocol well known to persons of ordinary skill in the art. In an exemplary implementation, the WIFI interface 607 and the cellular network (GSM or CDMA) adaptor 608 send and receive electrical or electromagnetic signals that carry digital data streams representing various types of information.

In one or more embodiments, the Internet 624 typically provides data communication through one or more sub-networks to other network resources. Thus, the computerized system 600 is capable of accessing a variety of network resources located anywhere on the Internet 624, such as web servers, other content servers as well as other network data storage resources. In one or more embodiments, the computerized system 600 is configured send and receive messages, media and other data, including application program code, through a variety of network(s) including Internet 624 by means of the network interface 605. In the Internet example, when the computerized system 600 acts as a network client, it may request code or data for an application program executing on the computerized system 600. Similarly, it may send various data or computer code to other network resources.

In one or more embodiments, the computerized system 600 uses the network interface 605 to send request(s), via the Internet 624, such as HTTP requests, to the servers 3 and receive various information, including, without limitation, the aforesaid information displayed to the user using the user interface shown in FIGS. 4 and 5.

In one or more embodiments, the functionality described herein is implemented by computerized system 600 in response to processor 601 executing one or more sequences of one or more instructions contained in the memory 612. Such instructions may be read into the memory 612 from another computer-readable medium. Execution of the sequences of instructions contained in the memory 612 causes the processor 601 to perform the various process steps described herein. In alternative embodiments, hard-wired circuitry may be used in place of or in combination with software instructions to implement the embodiments of the invention. Thus, embodiments of the invention are not limited to any specific combination of hardware circuitry and software.

The term “computer-readable medium” as used herein refers to any medium that participates in providing instructions to processor 601 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 901 for execution. For example, the instructions may initially be carried on a magnetic disk from a remote computer. Alternatively, a remote computer can load the instructions into its dynamic memory and send the instructions over the Internet 624. Specifically, the computer instructions may be downloaded into the memory 612 of the computerized system 600 from the foresaid remote computer via the Internet 624 using a variety of network data communication protocols well known in the art.

In one or more embodiments, the memory 612 of the computerized system 600 may store any of the following software programs, applications or modules:

1. Operating system (OS) 613, which may be a mobile operating system for implementing basic system services and managing various hardware components of the computerized system 600. Exemplary embodiments of the operating system 613 are well known to persons of skill in the art, and may include iOS, Android, Windows Mobile or any other now known or later developed mobile operating system(s).

2. Mobile applications 614 may include, for example, a set of software applications executed by the processor 601 of the computerized system 600, which cause the computerized mobile system 600 to perform certain predetermined functions, such as receive the GPS position data and transmit it to the server 3, to receive information for displaying to the user and to display this information to the user using the graphical user interface displayed on the display device as described above in connection with FIGS. 4 and 5. In one or more embodiments, the mobile applications 614 may include, for example, the client application 615.

3. Data storage 616 may be used, for example, for storing client device location information as well as other data, such as points earned by the user, distance traveled, trip duration as well as other suitable statistical information.

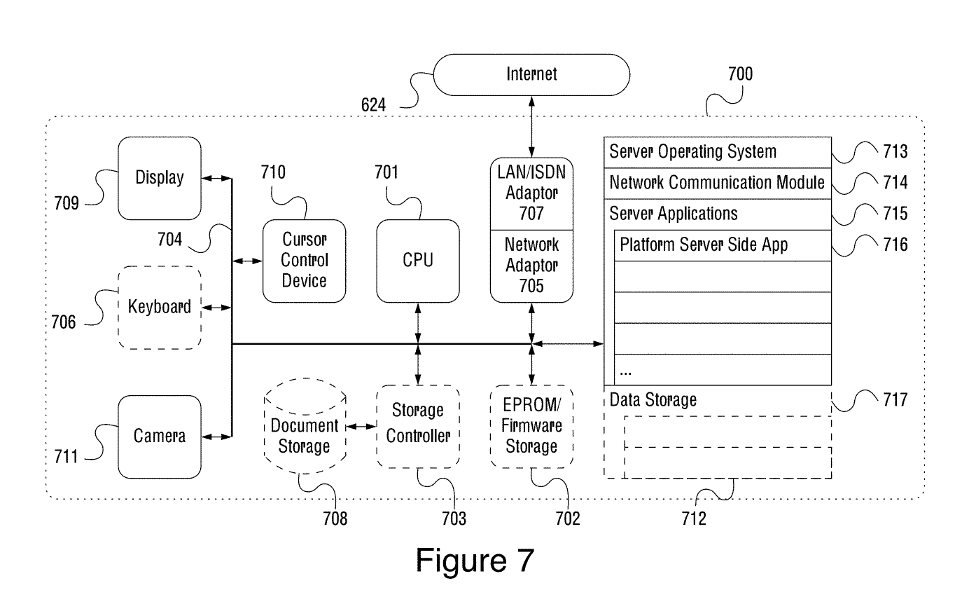

FIG. 7 illustrates an exemplary embodiment of a computerized server system 700 which could be used, for example, as the server 3 of the inventive system for evaluating effectiveness of outdoor or indoor advertisement(s) shown in FIG. 1. It should be noted that other components of the described system such as the database engine 4 may be also deployed on the computerized server system 700.

In one or more embodiments, the computerized server system 700 may incorporate a data bus 704, which may be substantially similar and may perform substantially similar functions as the data bus 704 of the computerized system 600 illustrated in FIG. 6. In various embodiments, the data bus 704 may use the same or different interconnect and/or communication protocol as the data bus 604. The one or more processors (CPUs) 701, the network adaptor 705, the EPROM/Firmware storage 702, the display device 709 and the keyboard 706 of the computerized server system 700 may be likewise substantially similar to the respective processor 601, the network interface 605, the EPROM/Firmware storage 602, the display device 609 and the keyboard 606 of the computerized system 600, except that the former components are deployed in a server platform configuration. In various implementations, the one or more processor 701 may have substantially increased processing power as compared with the processor 601.

In addition to the input device 706 (keyboard), the computerized server system 700 may additionally include a cursor control device 710, such as a mouse, a trackball, or cursor direction keys for communicating direction information and command selections to processor 701 and for controlling cursor movement on the display device 709. This input device typically has two degrees of freedom in two axes, a first axis (e.g., x) and a second axis (e.g., y), that allows the device to specify positions in a plane.

The LAN/ISDN adaptor 707 of the computerized server system 700 may be implemented, for example, using an integrated services digital network (ISDN) card or a modem to provide a data communication connection to a corresponding type of telephone line, which is interfaced with the Internet 624 using Internet service provider's hardware (not shown). As another example, the LAN/ISDN adaptor 707 may be a local area network interface card (LAN NIC) to provide a data communication connection to a compatible LAN and the Internet 624. To store various data files, the computerized server system 700 may be provided with data storage 708, for storing various statistical data to be displayed to the user by means of a storage controller 703. The camera 711 may be used to acquire images and/or video of various objects.

In one or more embodiments, the memory 712 of the computerized server system 700 may store any of the following software programs, applications, modules and/or data:

1. A server operating system (OS) 713, which may be an operating system for implementing basic system services and managing various hardware components of the computerized server system 700. Exemplary embodiments of the server operating system 713 are all well known to persons of skill in the art, and may include Windows Server, Mac OS, Unix, AIX, FreeBSD, Linux, as well as any now known or later developed operating systems.

2. A network communication module 714 may incorporate, for example, one or more network protocol stacks which are used to establish a networking connection between the computerized server system 700 and the various network entities of the Internet 624, such as the computerized mobile system 600, using the network adaptor 705 working in conjunction with the LAN/ISDN adaptor 707.

3. Server applications 615 may include, for example, a set of software applications executed by one or more processors 701 of the computerized server system 700, which cause the computerized server system 700 to perform certain predetermined functions or tasks. In one or more embodiments, the server applications 715 may include the server side application 716, the functionality of which was described in detail above. Additionally provided may be a database management system 717 for storing and managing access to various information as described in detail above.

4. Data storage 719 may be used, for example, for storing the user data, the geographical position data, the tariff data, the user point data, as well as any other data items described above, which may be stored in a form of one or more database tables containing database records.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for evaluating effectiveness of outdoor or indoor advertisement(s). It is intended that the specification and examples be considered as exemplary only, with a true scope and spirit of the invention being indicated by the following claims.

What is claimed is:

1. A computer-implemented method for calculating user incentives in connection with outdoor or indoor advertisement(s), the method being performed in connection with a computerized system comprising a central processing unit, a positioning device, a display device and a memory, the computer-implemented method comprising:
a. using the central processing unit to post a photo or a video taken by a user in a social network;
b. checking whether the posted photo or video is still available in the social network;
c. if the posted photo or video is still available, determining a level of other user interaction with the posted photo or video;
d. specifying a rate information applicable to an advertising campaign corresponding to the posted photo or video and the social network; and
e. calculating a number of points (P) earned by the user for the posted photo or video in the social network based on determined rate information and the determined level of interaction.

2. The computer-implemented method of claim 1, wherein the level of other user interaction with the posted photo or video is determined based on a number (L) of “likes” collected by the posted photo or video in the social network.

3. The computer-implemented method of claim 1, wherein the level of other user interaction with the posted photo or video is determined based on a number of reposts (S) collected by the posted photo or video in the social network.

4. The computer-implemented method of claim 1, wherein the level of other user interaction with the posted photo or video is determined based on a number of views (V) of the posted photo or video in the social network.

5. The computer-implemented method of claim 1, wherein the rate information comprises a price per friend/follower (pF), price per like (pL) and price per repost (pS), limit for friend/follower (limF), limit for likes (limL) and limit for reposts (limS), price per watched video (pV) and limit for number of times video can be watched (limV).

6. The computer-implemented method of claim 1, further comprising determining a number (F) of friends and followers of a profile of the user in the social network, wherein the number of points (P) earned by the user for the posted photo in the social network is calculated according to a formula:
P=if(F>limF;LOG(F;2)*pF*limF/LOG(limF;2);pF*F)+if(L>limL;LOG(L;2)*pL*limL/LOG(limL;2);pL*L)+if(S>limS;LOG(S;2)*pS*limS/LOG(limS;2);pS*S)
or any other function that is linear to number of friends, number of likes, number of reposts and switches to logarithmic after a certain limit and wherein for posted video the formula is:
P=if(V>limV;LOG(V;2)*pV*limV/LOG(limV;2);pV*V)+if(L>limL;LOG(L;2)*pL*limL/LOG(limL;2);pL*L)+if(S>limS;LOG(S;2)*pS*limS/LOG(limS;2);pS*S)
or any other function that is linear to number of times video was watched, number of likes, number of reposts and switches to logarithmic after a certain limit.

7. The computer-implemented method of claim 1, wherein checking whether the posted photo or video is still available in the social network during a predetermine period of time comprises determining whether the posted photo or video exists and can be accessed without any restriction by any user.

8. The computer-implemented method of claim 7 wherein if the posted photo or video is not available to everybody, it is treated as “unavailable”.

9. A computer-implemented method for evaluating effectiveness of outdoor or indoor advertisement(s), the method being performed in connection with a computerized system comprising a central processing unit, a positioning device, a display device and a memory, the computer-implemented method comprising:
a. receiving data on a plurality of postings made for a predetermined advertising campaign,
b. associating each posting of the plurality of postings with an advertisement object of a plurality of advertisement objects; and
c. determining the effectiveness of outdoor or indoor advertisement(s) based on statistical analysis of a number of associated postings.

10. The computer-implemented method of claim 9, further comprising computing, for each of the plurality of postings, an engagement rate.

11. The computer-implemented method of claim 9, wherein the each posting of the plurality of postings is associated with the advertisement object of the plurality of advertisement objects by means of an algorithm for building Voronoi diagram.

12. The computer-implemented method of claim 9, further comprising using statistical distribution of advertisement objects comprising groups of best and worst performing objects in the predetermined advertising campaign, average performance of advertising objects in the predetermined advertising campaign compared to average for other campaigns in a database, comparison of performance of the advertising object among several advertising campaigns and other analytics.

13. The computer-implemented method of claim 9, further comprising using standard computational instruments to determine statistical distribution of creatives, comprising groups of best and worst performing creatives in the predetermined advertising campaign, average performance of creative in the predetermined advertising campaign compared to average for other campaigns in a database, comparison of performance of creatives located at the advertising object among several advertising campaigns (can be helpful to determine social demography and profile of audience around this advertising object) and other analytics.

14. The computer-implemented method of claim 13, wherein the engagement rate comprises a first engagement rate computed based on a number of likes of the posting.

15. The computer-implemented method of claim 14, further comprising determining a number (F) of friends and followers of a profile of the user in the social network, wherein the first engagement rate is computed by dividing the number of likes of the posting by a number of friends and followers of a corresponding user who made the posting.

16. The computer-implemented method of claim 13, wherein the engagement rate comprises a second engagement rate calculated based on a number of reposts of the posting.

17. The computer-implemented method of claim 16, further comprising determining a number (F) of friends and followers of a profile of the user in the social network, wherein the second engagement rate is computed by dividing the number of reposts of the posting by a number of friends and followers of a corresponding user who made the posting.

18. The computer-implemented method of claim 13, wherein the engagement rate comprises a third engagement rate calculated based on a number of views of the posting.

19. The computer-implemented method of claim 18, further comprising determining a number (F) of friends and followers of a profile of the user in the social network, wherein the third engagement rate is computed by dividing the number of views of the posting by a number of friends and followers of a corresponding user who made the posting.

20. A non-transitory computer-readable medium embodying a set of computer-executable instructions, which, when executed in a computerized system comprising a central processing unit, a positioning device, a display device and a memory, cause the computerized system to perform a computer-implemented method for calculating user incentives in connection with outdoor or indoor advertisement(s), the method comprising:
a. using the central processing unit to post a photo or a video taken by a user in a social network;
b. checking whether the posted photo or video is still available in the social network;
c. if the posted photo or video is still available, determining a level of other user interaction with the posted photo or video;
d. specifying a rate information applicable to an advertising campaign corresponding to the posted photo or video and the social network; and
e. calculating a number of points (P) earned by the user for the posted photo or video in the social network based on determined rate information and the determined level of interaction.

21. The non-transitory computer-readable medium of claim 20, wherein the level of other user interaction with the posted photo or video is determined based on a number (L) of “likes” collected by the posted photo or video in the social network.

22. The non-transitory computer-readable medium of claim 20, wherein the level of other user interaction with the posted photo or video is determined based on a number of reposts (S) collected by the posted photo or video in the social network.

23. The non-transitory computer-readable medium of claim 20, wherein the level of other user interaction with the posted photo or video is determined based on a number of views (V) of the posted photo or video in the social network.

24. The non-transitory computer-readable medium of claim 20, wherein the rate information comprises a price per friend/follower (pF), price per like (pL) and price per repost (pS), limit for friend/follower (limF), limit for likes (limL) and limit for reposts (limS), price per watched video (pV) and limit for number of times video can be watched (limV).

25. The non-transitory computer-readable medium of claim 20, wherein the method further comprises determining a number (F) of friends and followers of a profile of the user in the social network, wherein the number of points (P) earned by the user for the posted photo in the social network is calculated according to a formula:
P=if(F>limF;LOG(F;2)*pF*limF/LOG(limF;2);pF*F)+if(L>limL;LOG(L;2)*pL*limL/LOG(limL;2);pL*L)+if(S>limS;LOG(S;2)*pS*limS/LOG(limS;2);pS*S)
or any other function that is linear to number of friends, number of likes, number of reposts and switches to logarithmic after a certain limit and wherein for posted video formula is going to be:
P=if(V>limV;LOG(V;2)*pV*limV/LOG(limV;2);pV*V)+if(L>limL;LOG(L;2)*pL*limL/LOG(limL;2);pL*L)+if(S>limS;LOG(S;2)*pS*limS/LOG(limS;2);pS*S)
or any other function that is linear to number of times video was watched, number of likes, number of reposts and switches to logarithmic after a certain limit.

26. The non-transitory computer-readable medium of claim 20, wherein checking whether the posted photo or video is still available in the social network during a predetermine period of time comprises determining whether the posted photo or video exists and can be accessed without any restriction by any user.

27. The non-transitory computer-readable medium of claim 26 wherein if the posted photo or video is not available to everybody, it is treated as “unavailable”.

28. A non-transitory computer-readable medium embodying a set of computer-executable instructions, which, when executed in a computerized system comprising a central processing unit, a positioning device, a display device and a memory, cause the computerized system to perform a computer-implemented method for evaluating effectiveness of outdoor or indoor advertisement(s), the method comprising:
a. receiving data on a plurality of postings made for a predetermined advertising campaign,
b. associating each posting of the plurality of postings with an advertisement object of a plurality of advertisement objects; and
c. determining the effectiveness of outdoor or indoor advertisement(s) based on statistical analysis of a number of associated postings.

29. The non-transitory computer-readable medium of claim 28, further comprising computing, for each of the plurality of postings, an engagement rate.

30. The non-transitory computer-readable medium of claim 28, wherein the each posting of the plurality of postings is associated with the advertisement object of the plurality of advertisement objects by means of an algorithm for building Voronoi diagram.

31. The non-transitory computer-readable medium of claim 28, further comprising using statistical distribution of advertisement objects comprising groups of best and worst performing objects in the predetermined advertising campaign, average performance of advertising objects in the predetermined advertising campaign compared to average for other campaigns in a database, comparison of performance of the advertising object among several advertising campaigns and other analytics.

32. The non-transitory computer-readable medium of claim 28, further comprising using standard computational instruments to determine statistical distribution of creatives, comprising groups of best and worst performing creatives in the predetermined advertising campaign, average performance of creative in the predetermined advertising campaign compared to average for other campaigns in a database, comparison of performance of creatives located at the advertising object among several advertising campaigns (can be helpful to determine social demography and profile of audience around this advertising object) and other analytics.

33. The non-transitory computer-readable medium of claim 32, wherein the engagement rate comprises a first engagement rate computed based on a number of likes of the posting.

34. The non-transitory computer-readable medium of claim 33, wherein the method further comprises determining a number (F) of friends and followers of a profile of the user in the social network, wherein the first engagement rate is computed by dividing the number of likes of the posting by a number of friends and followers of a corresponding user who made the posting.

35. The non-transitory computer-readable medium of claim 32, wherein the engagement rate comprises a second engagement rate calculated based on a number of reposts of the posting.

36. The non-transitory computer-readable medium of claim 35, wherein the method further comprises determining a number (F) of friends and followers of a profile of the user in the social network, wherein the second engagement rate is computed by dividing the number of reposts of the posting by a number of friends and followers of a corresponding user who made the posting.

37. The non-transitory computer-readable medium of claim 32, wherein the engagement rate comprises a third engagement rate calculated based on a number of views of the posting.

38. The non-transitory computer-readable medium of claim 37, wherein the method further comprises determining a number (F) of friends and followers of a profile of the user in the social network, wherein the third engagement rate is computed by dividing the number of views of the posting by a number of friends and followers of a corresponding user who made the posting.
